(19) United States
(12) Patent Application Publication
(10) Pub. No.: US 2023/0321743 A1
(43) Pub. Date: Oct. 12, 2023

(54) Clamping Techniques for High Temperature Assembly Processes

(71) Applicant: NVIDIA Corporation, Santa Clara, CA (US)

(72) Inventor: Marc Davis, Hillsboro, OR (US)

(21) Appl. No.: 17/718,113

(22) Filed: Apr. 11, 2022

(51) Int. Cl. B23K 3/08

(52) U.S. Cl. CPC B23K 3/087

(57) ABSTRACT

Methods and apparatus are described for high temperature assembly processes. In an example embodiment, a void defined by an expandable enclosure is filled with a quantity of gas. A clamping structure is configured to receive components to be joined and to apply a force from the surface of the enclosure to at least one of the components such that the components are urged together responsive to heating the quantity of gas. Example methods include providing a workpiece that comprises two or more components with a joining material disposed between them, providing an expandable enclosure that contains a volume of gas, heating the workpiece and the volume of gas, and coupling a force from the expandable enclosure to the workpiece such that the force urges the components together.

### BACKGROUND

Manufacturing processes often require joining separate components such that a fixed spatial relationship is maintained between the components after joining. When the components to be joined are made of metal, such a process may include one or more high temperature steps during which brazing or soldering occurs.

During both brazing and soldering, metal components are brought in close proximity to one another, and a soldering or a brazing material is placed between or adjacent to joining surfaces located on each of the components. Heat is applied to the joining surfaces and to the soldering or brazing material until the soldering or brazing material flows. The molten material fills the area to be joined and bonds with the joining surfaces of the components. After the heat is removed, the soldering or brazing material solidifies. The result is a strong mechanical joint between the components—a joint that may also exhibit desirable electrical or thermal conduction characteristics.

One difference between soldering and brazing is the temperatures at which the two techniques are performed. Soldering typically is performed at temperatures at or below about 450° C., while brazing typically is performed at temperatures at or above 450° C. Another difference between soldering and brazing relates to the joining materials used in the two processes. Various types of materials are available for use in each process, each of the materials exhibiting different melting points. Materials having lower melting points are used in soldering, while materials with higher melting points are used in brazing. In some assembly processes, multiple components are joined in a series of separate manufacturing steps during which different bonds are formed at different temperatures. In the latter types of processes, the highest temperature joining steps are typically performed first, followed by joining steps performed at successively lower temperatures so as not to re-flow the joints created during earlier steps.

In any high temperature manufacturing process including those just described, several problems can arise in relation to holding the components together with suitable reliability and precision while the high temperature joining steps are being performed.

### BRIEF DESCRIPTION OF THE DRAWINGS

Such problems can be addressed beneficially with techniques that will be described below in relation to the following drawings.

FIG. 1 illustrates an example assembly apparatus including an expandable gas filled enclosure in accordance with embodiments.

FIG. 2 illustrates the assembly apparatus of FIG. 1 after the gas filled enclosure has expanded.

FIG. 3 illustrates an example high temperature assembly process in accordance with embodiments.

FIG. 4 illustrates an assembly apparatus being inserted into and removed from a heating oven or furnace in accordance with embodiments.

FIG. 5 illustrates an assembly apparatus passing through a heating oven or furnace on a conveyance in accordance with embodiments.

FIG. 6 illustrates an assembly apparatus with a retaining wall that surrounds peripheral edges of a gas filled enclosure in accordance with embodiments.

FIG. 7 illustrates the assembly apparatus of FIG. 1 with an interface member interposed between the gas-filled enclosure and a component to be assembled, in accordance with embodiments.

FIG. 8 schematically illustrates an assembly apparatus that includes one or more levers configured to apply force from an expandable gas filled enclosure, in accordance with embodiments.

FIG. 9 schematically illustrates an assembly apparatus that includes one or more pulleys configured to apply force from an expandable gas filled enclosure, in accordance with embodiments.

FIG. 10 schematically illustrates an assembly apparatus that includes one or more wedges configured to apply force from an expandable gas filled enclosure, in accordance with embodiments.

FIG. 11 illustrates an assembly apparatus having multiple gas filled enclosures, in accordance with embodiments.

### DETAILED DESCRIPTION

### Nomenclature

This disclosure describes multiple embodiments by way of example and illustration. It is intended that characteristics and features of all described embodiments may be combined in any manner consistent with the teachings, suggestions and objectives contained herein. Thus, phrases such as “in an embodiment,” “in one embodiment,” and the like, when used to describe embodiments in a particular context, are not intended to limit the described characteristics or features only to the embodiments appearing in that context.

The phrases “based on” or “based at least in part on” refer to one or more inputs that can be used directly or indirectly in making some determination or in performing some computation. Use of those phrases herein is not intended to foreclose using additional or other inputs in making the described determination or in performing the described computation. Rather, determinations or computations so described may be based either solely on the referenced inputs or on those inputs as well as others. The phrase “configured to” as used herein means that the referenced item, when operated, can perform the described function. In this sense an item can be “configured to” perform a function even when the item is not operating and is therefore not currently performing the function. Use of the phrase “configured to” herein does not necessarily mean that the described item has been modified in some way relative to a previous state. “Coupled” as used herein refers to a connection between items. Such a connection can be direct or can be indirect through connections with other intermediate items. Terms used herein such as “including,” “comprising,” and their variants, mean “including but not limited to.” Articles of speech such as “a,” “an,” and “the” as used herein are intended to serve as singular as well as plural references except where the context clearly indicates otherwise.

### Problem Specifics

Prior art techniques for holding components together during high temperature joining processes, such as soldering or brazing processes, include conventional clamps and weights.

Conventional clamps are problematic because the space between components to be joined often decreases when the brazing or soldering material disposed between them flows. Conventional clamps do not adjust to the resulting decrease in distance between the components. Consequently, they fail to maintain the force necessary to hold the components in place during the joining process. While springs have been used in attempts to cause conventional clamps to adjust to the decrease in distance between the components, springs quickly lose temper after they have been exposed to the high temperatures at which brazing and soldering are performed. (It is not uncommon, for example, to perform brazing at temperatures around 1400 degrees Fahrenheit.) Springs are therefore unsuitable for repeated use because they become permanently soft after exposure to such temperatures.

For assemblies that can be clamped vertically during the joining process, heavy weights have been placed on top of the assembly so that the force of gravity helps to keep a force applied to the components as the distance between them decreases during joining. Heavy weights, however, by definition have significant mass, and the mass of the weights must be heated to the same temperature as the workpieces in order to achieve a proper joint between the workpieces. The mass of the weights wastes energy during brazing or soldering because it absorbs heat that is generated by the oven or furnace, to no benefit. In addition, some assemblies do not lend themselves easily to vertical clamping during the joining process.

Improved techniques are therefore needed to hold components together with suitable reliability and precision while high temperature joining steps are being performed.

### Example Embodiments

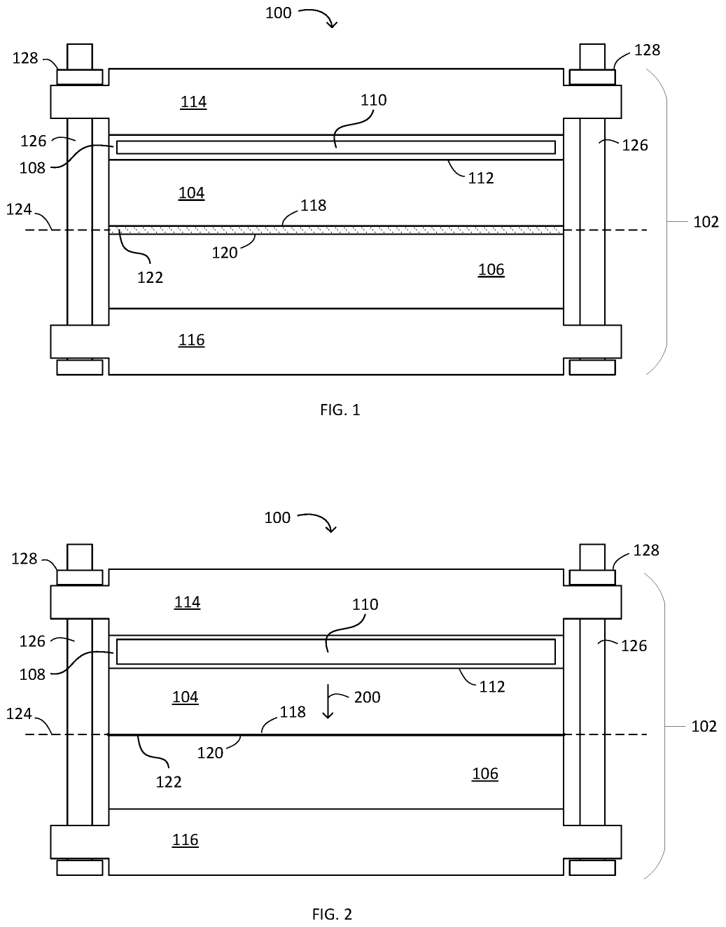

FIGS. 1 and 2 generically illustrate a class of assembly apparatus 100 according to some embodiments. The illustrated assembly apparatus includes a clamping structure 102 that is configured to receive two or more components 104, 106 for joining. The assembly apparatus also includes a substantially airtight enclosure 108. The enclosure, in turn, defines a void 110 inside it, and a quantity of gas is disposed inside the void. The enclosure is expandable in at least a first direction 200, such that heating the quantity of gas inside the void urges a surface 112 of the enclosure in direction 200. In the embodiment shown, members 114, 116 are constrained from moving away from one another by the clamping structure. Thus, when surface 112 is urged in direction 200, a force is applied to component 104 in direction 200. Consequently, components 104 and 106 are urged together responsive to heating the quantity of gas.

In embodiment 100, each of the components to be joined defines a respective joining surface 118, 120. A joining material 122 may be placed between the joining surfaces as shown. The joining material may comprise a brazing material or a soldering material, for example, suitable for the application. The clamping structure may be configured to receive the components with the joining material disposed between them such that the joining material—or, equivalently, the joining surfaces of the components—defines a joining plane 124. In such embodiments, the force may be applied in a direction substantially normal to the joining plane.

The clamping structure may be further configured to permit movement of the components 104, 106 toward one another in response to expansion of the expandable enclosure in direction 200. Such movement may enhance bonding between certain types of components as the joining material between them begins to flow when heated. In such embodiments, the expansion of expandable enclosure 108 ensures that a force is continuously applied to the components being joined—despite the reduction in distance between the components that may result when the joining material between them flows, as illustrated in FIG. 2.

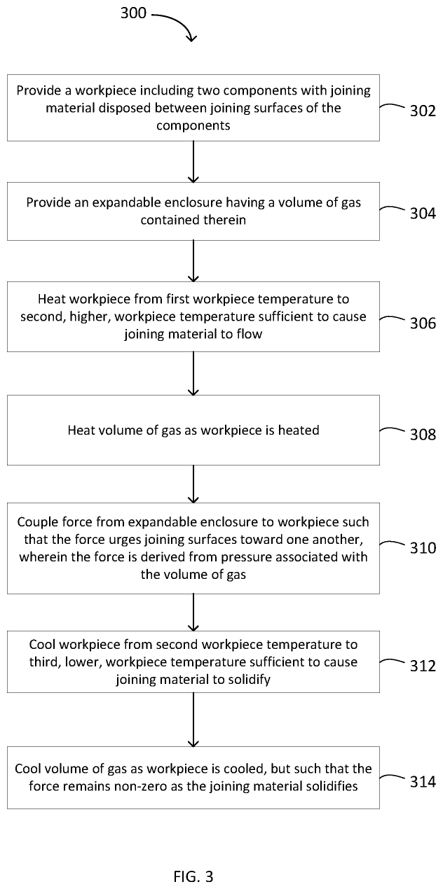

FIG. 3 generically illustrates a manufacturing method 300 accordance to an example class of embodiments. At step 302, a workpiece is provided that includes two or more components (e.g., 104, 106) with a joining material (e.g., 122) disposed between joining surfaces (e.g., 118, 120) of the components. At step 304, a substantially airtight expandable enclosure (e.g., 108) is provided having a volume of gas contained inside it. At step 306, the workpiece is heated from a first workpiece temperature (e.g., an initial temperature at which the joining material is not fluid) to a second, higher, workpiece temperature sufficiently high to cause the joining material to flow. At step 308, the volume of gas inside the expandable enclosure is also heated. At step 310, a force derived from pressure created by heating the volume of gas is coupled from the expandable enclosure to the workpiece in a manner such that the force urges the joining surfaces of the components toward one another. In some embodiments, steps 306, 308, and 310 may be performed simultaneously. In step 312, the workpiece is cooled from the second workpiece temperature to a third, lower, workpiece temperature that is sufficiently low to cause the joining material to solidify. The third workpiece temperature may be, but need not be, the same as the first workpiece temperature. In step 314, the volume of gas inside the expandable enclosure may also be cooled, but in a manner such that the force derived from the gas contained therein remains non-zero as the joining material solidifies. For example, the expandable enclosure may be arranged in relation to the workpiece such that some force is applied to the workpiece by virtue of compression of the gas inside the enclosure, even when the enclosure and the workpiece are both at the initial temperature.

In some embodiments, the joining surfaces of the components may be allowed to move toward one another during steps 306-310, and the expandable enclosure may be allowed to expand responsive to the movement of the joining surfaces. In this manner, the force that is derived from the gas pressure within the enclosure may remain non-zero despite a reduction in distance between the components after the joining material flows and the joining surfaces of the components have moved toward one another.

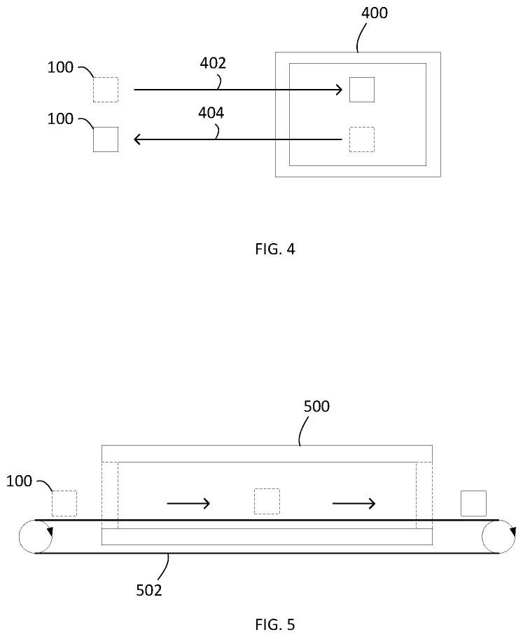

In further embodiments, such as those exemplified by embodiment 100, both the clamping structure and the expandable enclosure may be configured to fit within a chamber that can be heated—such as, for example, a heating oven or furnace. For example, as illustrated in FIG. 4, assembly apparatus 100 may be inserted into a heating oven or furnace 400 as shown at 402 to perform steps 306-310. The assembly apparatus may then be removed from the heating oven or furnace, as shown at 404, to perform steps 312-314. In other embodiments, steps 312-314 may be performed while the assembly apparatus remains in the heating oven or furnace by allowing the heating oven or furnace to cool before the assembly apparatus is removed therefrom. In still further embodiments (see FIG. 5), the assembly apparatus may be passed through a heating oven or furnace 500 on a conveyance, such as on a moving belt, chain, or surface 502. In the latter embodiments, steps 306-310 may be performed while the assembly apparatus in within the heating oven or furnace, and steps 312-314 may occur after the assembly apparatus exits the heating oven or furnace.

### Expandable Enclosures

Expandable enclosures for use in embodiments may be constructed in various ways as appropriate to a given application. In many applications, even a few thousandths of an inch of expansion may be sufficient to keep adequate force applied to a workpiece as the soldering or brazing material begins to flow and later solidifies after flowing. The amount of force generated by the expandable enclosure as it is heated may be controlled by regulating the amount of gas contained within the enclosure. Lighter weight expandable enclosures may be used for applications in which it is desirable to conserve energy during the heating process associated with flowing the joining material.

In one example class of embodiments, a suitable expandable enclosure may be fabricated from two sheets of high temperature stainless steel, such as INCONEL, which is a commercially available material manufactured by the Special Metals Corporation. The edges of the two sheets of steel may be welded around their peripheries to form a substantially airtight enclosure while the sheets themselves remain sufficiently pliable to accommodate expansion and contraction of the gas volume contained between them. For example, each sheet may have a thickness on the order of 30 thousands of an inch to achieve sufficient strength while retaining sufficient pliability. Other thicknesses may also be used. The gas volume may be inserted into the enclosure using a fill tube, which may be sealed after insertion of the gas volume. In other embodiments, the welds may be performed in an environment that is already flooded with the gas that is to be sealed within the enclosure. In the latter embodiments, no fill tube may be necessary. Instead, the ambient gas may be allowed to fill a pocket formed between the two sheets before they are welded together. In still further embodiments, the gas volume may be contained in an insertable enclosure such as a plastic bag or pillow, which may itself be sealed between the metal sheets to form the expandable enclosure.

In most applications, an inert gas would be an appropriate choice for inclusion in the expandable enclosure so as to avoid corrosion of the enclosure. For example, the gas volume may be Argon gas, Helium gas, or Neon gas. Other materials may also be used. In some applications, for example, the type of gas may be chosen according to its expansion properties.

In further embodiments, a suitable expandable enclosure may be constructed using a block of soft metal, such as Copper. In such embodiments, a void may be formed inside the block such that the void is large enough to contain the volume of gas. The walls of the block may be made thin enough to allow them to flex outwardly in response to gas pressure inside the void, but strong enough to contain the pressure inside the block at the temperatures at which the joining material flows.

In still further embodiments, a suitable expandable enclosure may be constructed by boring a hole or pocket within a block of metal, adding a rigid piston to fit within the hole or pocket, and using a sealed expandable volume or pillow of gas to drive the piston as the gas expands.

Other types of expandable enclosures may also be employed as appropriate to the application.

### Clamping Structures

As persons having skill in the art will appreciate, clamping structures suitable for use in embodiments may vary depending on the application. The clamping structure, for example, may form part of a jig that is specifically adapted to the shapes and sizes of the components of the workpiece to be jointed.

By way of example, a clamping structure such as structure 102 shown in FIGS. 1 and 2 may be constructed as a steel frame comprising plates and/or bars as needed to adapt to the workpiece. The frame may be constructed using high temperature steel (such as INCONEL or stainless, for example). The frame may be held together around the workpiece using removeable fasteners such as bolts 126 and nuts 128. The bolts and nuts may be made using the same material as the frame, or they may be made using a different material such as Copper with a suitable lubricant applied to the nuts to reduce galling from heating and repeated use. Other materials, structures, and/or fasteners may also be used.

Suitable clamp structures will be sufficiently right to enable the force derived from the gas pressure within the expandable enclosure to be applied to the workpiece as the gas volume is heated. In most applications, the clamping structure need only be snug to the workpiece before the gas volume is heated.

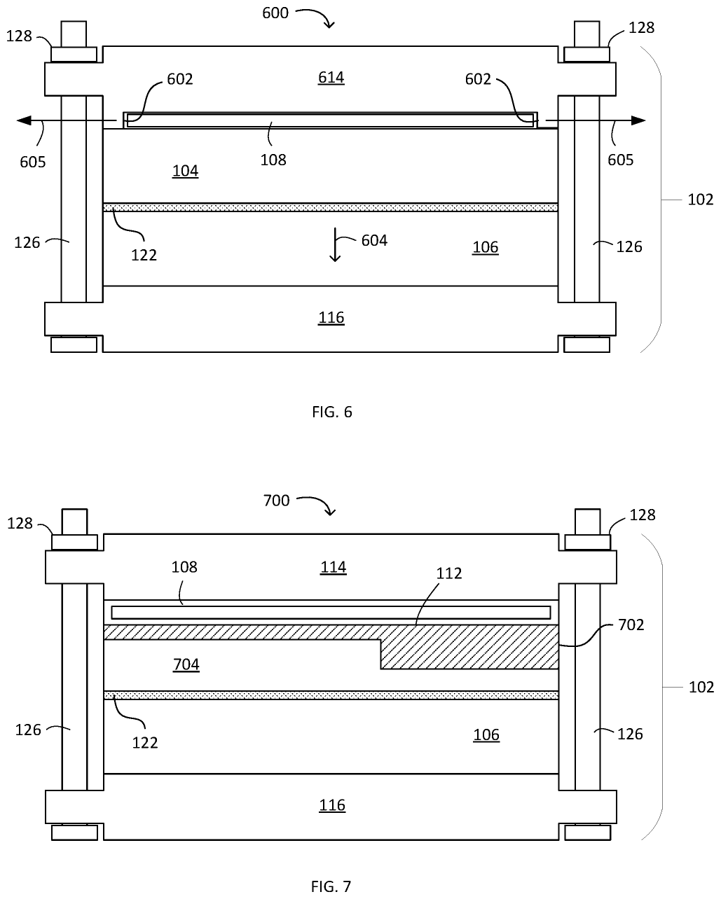

Depending on the construction of the expandable enclosure, it may be desirable in some embodiments to design the clamping structure such that it prevents extrusion of the expandable enclosure outside of the area under which its force is to be applied. In such embodiments, the clamping structure may be constructed as shown in FIG. 6, by way of example. Assembly apparatus 600 is shown in cross section in FIG. 6 to illustrate a retaining wall 602 that surrounds the peripheral edges of the expandable enclosure 108. The retaining wall may be formed using any material that is sufficiently rigid to prevent extrusion of the expandable enclosure in outward directions 605, so that the force derived from the pressure within the enclosure is applied to the workpiece in direction 604 as desired. In the illustrated embodiment, the retaining wall is formed as an integral part of clamping member 614. In other embodiments, the retaining wall may be a discrete component.

### Direct or Indirect Application of Force

In the example embodiments shown in FIGS. 1, 2 and 6, the clamping structure is configured such that the force derived from the expandable enclosure is applied to the workpiece by direct contact between a surface 112 of the expandable enclosure and a corresponding surface of one component 104 of the workpiece. In other embodiments, the force generated by the expandable enclosure may be coupled to the workpiece indirectly, as with an interface element disposed between the enclosure and one or more components of the workpiece.

FIG. 7 illustrates such embodiments by way of example. In embodiment 700, component 704 of the workpiece exhibits a varying high profile. In such cases, it may be advantageous to couple the force of the expandable enclosure to the workpiece indirectly, through an intermediate rigid element 702. The intermediate element may have a shape that corresponds in a complementary fashion to the height profile of the component. In this way, a constant height profile may be presented to the surface 112 of the expandable enclosure from which the force is applied. Such a technique may also be desirable for components that have an irregular surface, such as heat sinks or heat exchangers that comprise multiple fins. In the latter cases, the intermediate rigid element may be substantially flat so that the expandable enclosure does not billow downward to infiltrate the spaces between the fins as it expands.

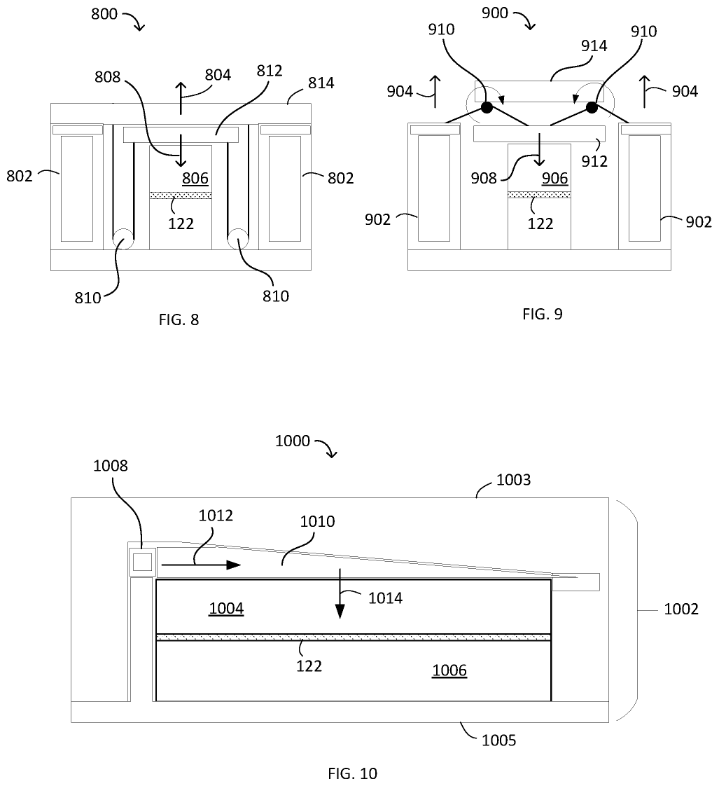

In various embodiments, the force of the expandable enclosure may also be coupled to the workpiece in a direction other than the direction in which the enclosure expands. FIGS. 8, 9 and 10 schematically illustrate three such cases by way of example.

In embodiment 800, shown in FIG. 8, a force generated by two expandable enclosures 802 is exerted in a direction 804. The force is shown being coupled to a workpiece component 806 in a direction 808, which is opposite to direction 804. The change of force direction may be accomplished by one or more pulleys 810 and, where appropriate, one or more intermediate rigid elements 812, 814. Various such pulley structures may be employed as appropriate to the nature of the workpiece and the application.

In embodiment 900, shown in FIG. 9, a force generated by two expandable enclosures 902 is exerted in a direction 904. The force is shown being coupled to a workpiece component 906 in a direction 908, which is opposite to direction 904. The change of force direction may be accomplished by one or more levers 910 and, where appropriate, one or more intermediate rigid elements 912, 914. In the illustrated embodiment, element 914 is substantially stationary, while levers 910 are free to rotate about their respective fulcrums, as shown. Various such lever structures may be employed as appropriate to the nature of the workpiece and the application.

In embodiment 1000, shown in FIG. 10, a force generated by an expandable enclosure 1008 is exerted in a direction 1012. The force is being coupled to a workpiece component 1004 in a direction 1014, which is oriented 90 degrees clockwise relative to force 1012. The change of force direction may be accomplished by one or more wedges 1010, as shown. In the illustrated embodiment, clamp elements 1003 and 1005 may be fastened together in any suitable manner to form a clamping structure 1002 such that workpiece components 1004, 1006 are urged together responsive to force 1014, which it itself derived from gas pressure inside enclosure 1008 as the gas volume therein is heated. When joining material 122 flows at temperature, the workpiece components may move toward one another, while force 1014 remains non-zero due to the expansion of enclosure 1008 and the movement of wedge 1010. Various such wedge arrangements may be employed as appropriate to the nature of the workpiece and the application.

In any of embodiments 800, 900, 1000, the pulley, lever, or wedge arrangement may be configured to apply the force with mechanical advantage, if desired.

### Application of Forces in Multiple Directions

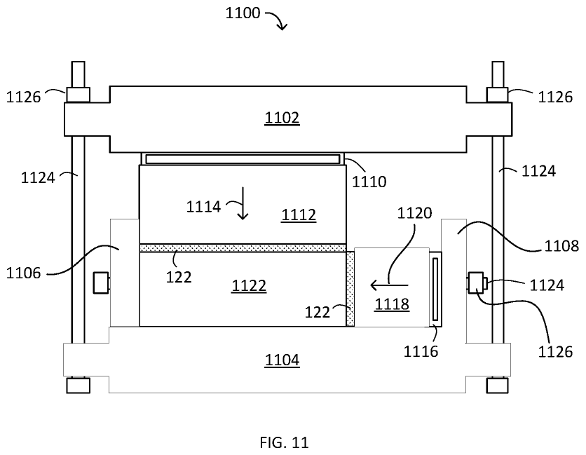

To accomplish joining components in more complex workpieces, it may be advantageous to apply forces in more than one direction during a joining step. FIG. 11 generically illustrates a class of embodiments 1100 that may be useful in such applications. In these embodiments, forces are applied to components of a workpiece in multiple directions. This may be accomplished by using multiple expandable enclosures 1110, 1116, each containing a volume of gas in a respective void, and by heating each of the expandable enclosures as generally described above to produce multiple forces. In the illustrated embodiment, the clamping structure includes a first set of clamping elements 1102, 1104 oriented vertically relative to one another, and a second set of clamping elements 1106, 1108 oriented horizontally relative to one another. Expandable enclosure 1110 is expandable in at least a vertical direction 1114, while expandable enclosure 1116 is expandable in at least a horizontal direction 1118. The vertically oriented clamping elements are configured to apply a force from expandable enclosure 1110 to workpiece component 1112 in the vertical direction 1114. The horizontally oriented clamping elements are configured to apply a force from expandable enclosure 1116 to workpiece component 1118 in the horizontal direction 1120. In this manner, both of components 1112 and 1118 may be joined with component 1122 in a single high temperature step, if desired.

Various such clamping arrangements may be devised to apply multiple forces to a workpiece at other angles, as appropriate to a given application. The clamping elements may be held in place in any suitable manner, such as with bolts 1124 and nuts 1126 as generally described above.

### Stepped Application of Forces

In embodiments such as embodiment 1100 in which more than one expandable enclosure is employed, it is possible to apply the forces derived from the expandable enclosures in a stepped manner, if desired. That is, a force from a first expandable enclosure may be applied to the workpiece, as the assembly is heated, before a force from a second expandable enclosure is applied to the workpiece.

A variety of mechanisms may be employed to accomplish such a stepped application of forces. One such mechanism is to vary the quantity of gas in each of the enclosures. For example, the quantity of gas contained within enclosure 1116 may less than the quantity of gas contained in enclosure 1110. Either in addition to, or instead of, varying the quantity of gas in each enclosure, the two enclosures may be fitted into the clamping structure with different initial tightness. For example, clamping elements 1102/1104 may be bolted tightly against enclosure 1110 before heat is applied to the assembly, while clamping elements 1106/1108 may be bolted more loosely, so that force 1114 is applied earlier during the heating process than is force 1120. If desired, an air gap may be included between an expandable enclosure and either the adjacent clamping element or the adjacent workpiece component, or both, so that the force from the expandable enclosure is not applied to the workpiece until the enclosure has expanded to fill the air gap. Other such mechanisms may also be devised.

### CONCLUSION

Any or all of the above-described apparatus elements and method steps may be combined to arrive at additional embodiments, which additional embodiments may be applied to workpieces different than those illustrated, or may be adapted to different manufacturing process than those given in the above examples.

Multiple specific embodiments have been described above and in the appended claims. Such embodiments have been provided by way of example and illustration. Persons having skill in the art and having reference to this disclosure will perceive various utilitarian combinations, modifications and generalizations of the features and characteristics of the embodiments so described. For example, steps in methods described herein may generally be performed in any order, and some steps may be omitted, while other steps may be added, except where the context clearly indicates otherwise. Similarly, components in structures described herein may be arranged in different positions or locations, and some components may be omitted, while other components may be added, except where the context clearly indicates otherwise. The scope of the disclosure is intended to include all such combinations, modifications, and generalizations as well as their equivalents.

What is claimed is:

1. Assembly apparatus, comprising:
an enclosure defining a void therein, wherein the enclosure is expandable in at least a first direction;
a quantity of gas disposed in the void of the enclosure such that heating the quantity of gas urges a surface of the enclosure toward the first direction; and
a clamping structure configured to receive components for joining and to apply a first force from the surface of the enclosure to at least a first one of the components such that the components are urged together responsive to heating the quantity of gas.

2. Apparatus according to claim 1, wherein:
both the clamping structure and the enclosure are configured to fit within a chamber that can be heated.

3. Apparatus according to claim 1, wherein:
the clamping structure is configured to receive the components with a joining material disposed between the components such that the joining material generally defines a joining plane; and
the first force is applied to the first component in a direction substantially normal to the joining plane.

4. Apparatus according to claim 1, wherein:
the clamping structure is configured such that the first force is applied by direct contact between the surface of the enclosure and the first component.

5. Apparatus according to claim 1, wherein:
the clamping structure is configured such that the first force is applied from the surface of the enclosure to the first component through an intermediate rigid element.

6. Apparatus according to claim 5, wherein:
the intermediate rigid element comprises a coupling member having a shape that corresponds to a portion of the first component.

7. Apparatus according to claim 1, wherein:
the clamping structure comprises a retaining wall surrounding peripheral edges of the enclosure sufficient to prevent extrusion of the enclosure as the quantity of gas is heated.

8. Apparatus according to claim 1, wherein:
the clamping structure is configured to permit movement of the components toward one another responsive to expansion of the enclosure and to flowing of joining material disposed between the components.

9. Apparatus according to claim 1, further comprising:
one or more pulleys, levers, or wedges configured to apply the first force from the surface of the enclosure to the first component.

10. Apparatus according to claim 9, wherein:
the one or more pulleys, levers, or wedges are configured to apply the first force from the surface of the enclosure to the first component in a direction other than the first direction.

11. Apparatus according to claim 9, wherein:
the one or more pulleys, levers, or wedges are configured to apply the first force from the surface of the enclosure to the first component with mechanical advantage.

12. Apparatus according to claim 1, further comprising:
a second enclosure defining a second void therein, wherein the second enclosure is expandable in at least a second direction;
a second quantity of gas disposed in the second void such that heating the second quantity of gas urges a surface of the second enclosure toward the second direction; and
wherein the clamping structure is configured to apply, responsive to heating the second quantity of gas, a second force from the surface of the second enclosure to at least one of the components.

13. Apparatus according to claim 12, wherein:
the second force is applied to the at least one component in a direction other than the first direction.

14. Apparatus according to claim 12, wherein:
the first and second forces are applied in a stepped manner as the first and second quantities of gas are heated.

15. Apparatus according to claim 14, wherein:
the stepped application of forces is achieved by differing the first and second quantities of gas.

16. Apparatus according to claim 14, wherein:
the stepped application of forces is achieved by differing respective first and second initial tightness of the first and second enclosures within the clamping structure before the first and second quantities of gas are heated.

17. Apparatus according to claim 16, wherein:
the stepped application of forces is achieved by including an air gap between at least one of the first and second enclosures and an adjacent clamping element or workpiece element before the first and second quantities of gas are heated.

18. A method of manufacturing, comprising:
providing a workpiece that includes two or more components and a joining material disposed between respective joining surfaces of the two or more components;
providing an expandable enclosure having a volume of gas contained therein;
heating the workpiece from a first workpiece temperature to a second workpiece temperature higher than the first workpiece temperature, wherein the joining material is not fluid at the first workpiece temperature and is fluid at the second workpiece temperature;
heating the volume of gas; and
coupling a force from the expandable enclosure to the workpiece such that the force urges a first joining surface of a first one of the components toward a second joining surface of a second one of the components as the workpiece is heated from the first workpiece temperature to the second workpiece temperature, wherein the force is derived from pressure created by heating the volume of gas.

19. A method according to claim 18, further comprising:
allowing the first joining surface to move toward the second joining surface while the force is being applied and as the joining material becomes fluid; and
allowing the expandable enclosure to expand responsive to the first joining surface moving toward the second joining surface, such that the force remains non-zero when the workpiece reaches the second workpiece temperature.

20. A method according to claim 18, further comprising:
cooling the workpiece from the second workpiece temperature to a third workpiece temperature lower than the second workpiece temperature, wherein the joining material is not fluid at the third workpiece temperature; and
cooling the volume of gas as the workpiece is cooled.

21. A method according to claim 20, wherein:
the force remains non-zero as the joining material solidifies.

22. A method according to claim 18, wherein:
the heating steps comprise inserting both the workpiece and the expandable enclosure in a chamber that can be heated.

23. A method according to claim 18, wherein:
the heating steps comprise passing the workpiece and the expandable enclosure through a heated chamber.

24. A method according to claim 18, wherein:
the joining material comprises a brazing material or a soldering material.

25. A method according to claim 18, wherein:
coupling the force from the expandable enclosure comprises coupling the force to an interface element disposed adjacent to the first component.

26. A method according to claim 18 wherein:
coupling the force from the expandable enclosure comprises coupling the force through a lever, a pulley, or a wedge.

27. A method according to claim 18, further comprising:
mounting the workpiece and the expandable enclosure in a clamping structure configured to resist movement of the second component while the joining surface of the first component is urged toward the joining surface of the second component.

28. A method according to claim 18, further comprising:
providing a second expandable enclosure having a second volume of gas contained therein;
heating the second volume of gas; and
coupling a second force from the second expandable enclosure to the workpiece such that the second force urges a different joining surface of one of the two or more components toward a corresponding different joining surface of another of the two or more components.

29. A method according to claim 28, wherein:
the force from the expandable enclosure and the second force from the second expandable enclosure are applied to the workpiece in different directions.

30. A method according to claim 28:
where the quantity of gas in the expandable enclosure comprises a first quantity of gas;
wherein the force from the expandable enclosure comprises a first force; and
further comprising applying the first force and the second force in a stepped manner as the first and second quantities of gas are heated.

31. A method according to claim 30, further comprising:
causing the first and second quantities of gas to differ before the first and second quantities of gas are heated.

32. A method according to claim 30, further comprising:
causing initial tightness of the first and second expandable enclosures within a clamping structure to differ before the first and second quantities of gas are heated.

33. A method according to claim 32, further comprising:
including an air gap between at least one of the first and second expandable enclosure and an adjacent clamping element or workpiece element before the first and second quantities of gas are heated.
